(19) United States
(12) Patent Application Publication
(10) Pub. No.: US 2007/0239704 A1
(43) Pub. Date: Oct. 11, 2007

(54) Aggregating citation information from disparate documents

(75) Inventors: Eric L. Burns, Seattle, WA (US); Jay Girotto, Kirkland, WA (US); Jon Michael Buschman, Seattle, WA (US); Qiang Wu, Sammamish, WA (US); Yue Liu, Issaquah, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/394,090

(22) Filed: Mar. 31, 2006

(51) Int. Cl. G06F 17/30

(52) U.S. Cl. 707/5

(57) ABSTRACT

A method and system to aggregate and present citations for disparate documents are provided. When the documents are similar to scholarly articles, the documents are further processed to extract citations associated with the document. The citations extracted from each document are utilized to generate a listing of citations that represents relationships between the documents. The content and relationships associated with the documents are displayed to provide a user with access to information for the disparate documents.

### CROSS-REFERENCE TO RELATED APPLICATION

Not applicable.

### STATEMENT REGARDING FEDERALLY SPONSORED RESEARCH OR DEVELOPMENT

Not applicable.

### BACKGROUND

Conventionally, commercial entities utilize subscriptions to generate citation information based on scholarly articles printed by a group of publishers. The subscriptions provide the commercial entities with printed scholarly articles having one or more citations. The commercial entities utilize one or more human reviewers to process the scholarly article to locate citations included in the scholarly article. The citations are noted and included in a listing to allow researchers in a field associated with the scholarly article to determine whether to cite the scholarly article in a future scholarly article associated with the field. Unfortunately, due to the time required for peer review and printing, there can be a significant delay between when an article is originally prepared and when the article is published. This time delay can prevent researchers from being aware of the most current research developments available in a given field.

Conventional internet-based citation methods have attempted to overcome the problems associated with the delay in collecting citations with commercial entities. The internet-based citation methods allow researchers to directly access internet-based documents that are published by authors in the field, where the internet-based documents are associated with the field of the future scholarly article. While the internet-based citation methods may overcome some of the problems associated with the delay, the internet-based citation methods create quality problems. For instance, the internet-based citation methods do not include intelligence to consistently extract appropriate citations from internet-based documents or to consistently verify that a citation is valid.

### SUMMARY

Embodiments of the invention relate to a system and method for aggregating citations for a corpus of documents having disparate formats and presenting relationships between the documents included in the corpus. The corpus of documents having disparate formats is gathered from one or more sources and a database is populated with the documents. The citations are extracted from the documents based on one or more rules, and each citation is associated with the corresponding document.

In an embodiment, presenting the corpus of documents having disparate format includes normalizing the corpus of documents. The normalized documents are processed to extract citation information that is utilized to rank each document in the corpus and to generate relationships based on the citation information. The ranked documents and relationships between the ranked documents are displayed.

In another embodiment, a system that provides citation information utilizes a citation service to process documents received from one or more sources. The citation service extracts citation information to generate relationships between the documents. Additionally, the citation service sends the relationships and citation information to a presentation component that graphically represents the relationships and citation information.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a network diagram that illustrates an exemplary computing environment, according to embodiments of the invention;

FIG. 2 is a component diagram that illustrates an exemplary citation service, according to embodiments of the invention;

FIG. 3 is a graph that illustrates the relationships between documents in a corpus of documents having disparate formats, according to an embodiment of the invention;

FIG. 4 is a graphical user interface that illustrates a display that categorizes the citation information, according to an embodiment of the invention;

FIG. 5 is a logic diagram that illustrates a method to create citation relationships, according to an embodiment of the invention; and

FIG. 6 is a logic diagram that illustrates a method to present a corpus of disparate documents, according to an embodiment of the invention.

### DETAILED DESCRIPTION

Embodiments of the invention gather documents and extract citation information from documents meeting specified criteria. The citation information extracted from the documents may be utilized to determine relationships between the documents. Furthermore, the relationships between the documents and document content are displayed. Accordingly, the citation information within a collection of documents is processed to utilize the citation information to define relationships between the documents.

Additionally, embodiments of the invention provide a computer system that presents the relationships associated with the extracted citation information. The computer system may include one or more data sources, a citation service and a presentation component. Once the citation information is extracted, the citation information is represented by as categories having a selection of citations or a graph having one or more relationships defined by the citation information. In an embodiment of the invention, the computer system may be communicatively connected to client devices through a communication network, and the client devices may include a portable device, such as, laptops, personal digital assistants, smart phones, etc. In another embodiment the documents may include legal documents, such as briefs or opinions.

As utilized throughout the disclosure, the term component refers to firmware, software, hardware, or any combination of the above.

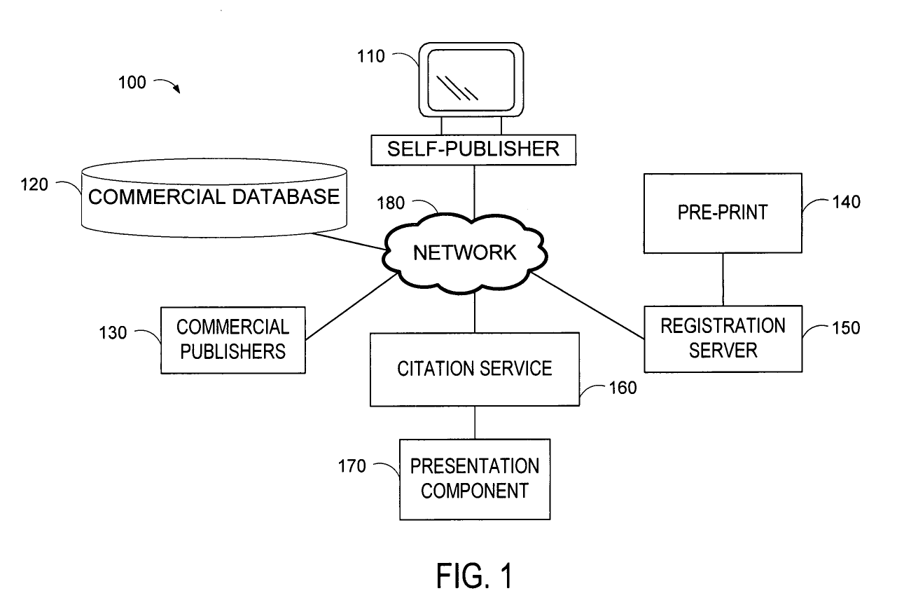

FIG. 1 is a network diagram that illustrates an exemplary computing environment 100, according to embodiments of the invention. The computing environment 100 is not intended to suggest any limitation as to scope or functionality. Embodiments of the invention are operable with numerous other special purpose computing environments or configurations. With reference to FIG. 1, the computing environment 100 includes a collection of data sources 110, 120, 130 and 140, where the data sources provide documents that may include citations. The computing environment 100 utilizes a collection service 160 and presentation component 170 to extract and present the relationships.

The collection of data sources includes a self-publisher 110, a commercial database 120, commercial publishers 130 and pre-print data 140. The self-publisher 110 may include authors that write scholarly articles. Typically, the self-publisher 110 includes authors that publicly disclose electronic documents or scholarly work. The commercial database 120 may store published documents from different journals and fields of research. In certain embodiments, a level of access is granted based on access payments, where the scope of the grant may include all documents. Similarly, a commercial publisher 130 provides access to published documents related to scholarly articles. Moreover, the collection of data sources include pre-print data 140, which may be scholarly articles that were approved for commercial publishing and are in queue to be commercially printed. The pre-print data 140 may be reproduced electronically with some restrictions on publishing and access. In an embodiment the restriction that governs access to the pre-print data includes Open Access Initiative (OAI) and Open Publishing Initiative (OPI). OPI provides protocols or rules that govern submission of electronic content, and OAI provide protocols or rules that govern access of the electronic content. In some embodiments, the pre-print data 140 and author may be registered by a registration service 150 to monitor access to the pre-print data 140.

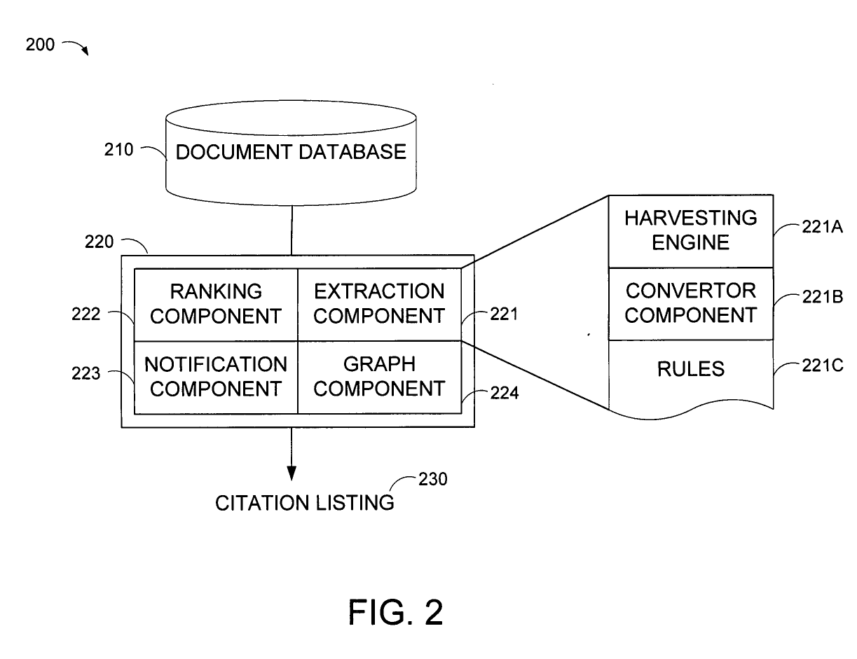

The citation service 160 communicates with the collection of data sources 110, 120, 130, 140 to gather a collection of documents. The citation service 160 processes the documents and generates a citation listing that may be utilized to determine relationships between different documents. Further discussion of the citation service is located below with respect to FIG. 2.

The presentation component 170 displays the relationships and documents in one or more categories. The categories may include, but are not limited to, published documents, Internet documents, and commercial documents. Published documents provide information on recently published documents. Internet documents may include self-published documents and pre-print data 140. Finally, the commercial documents category allows the user to organize and archive content related to documents that were published in the past. Accordingly, the relationships and documents may be grouped based on the category.

The citations service 160 communicates with the collection of data sources 110, 120, 130, and 140 to process the documents through a network 180. The network 180 may be a local area network, a wide area network, satellite network, wireless network or the Internet.

Documents from the data sources are processed by a citation service that gathers the documents, populates the documents in a document database and provides further processing to extract the relationships. Additionally, the citation service may generate a graph to represent the extracted relationships and to provide notifications to an author when another document cites an article created by the author.

FIG. 2 is a component diagram that illustrates an exemplary citation service 220, according to embodiments of the invention. The citation service 220 includes an extraction component, a ranking component, a notification component, and a graph generation component. The citation service 220 receives documents having varying formats from the collection of data sources and populates the document database 210 with the documents. The citation service 220 merges duplicates and searches the Internet when looking for documents with citations. Various embodiments of the invention can search .org, .gov, and .edu spaces, as well as “lab” space to determine whether a webpage is a research document or a personal page. For instance, document structure defined by the rules 221C provides information to determine whether the page has a predefined format. The rules 221C may specify a predefined format that may include one or more research paper parts, such as a conclusion, abstract, introduction, which aid in deciding that the document is a research paper. Similarly, the predefined format may include rules that define legal document parts.

While populating the database from the collection of data sources it is possible that the harvesting engine 221A may store duplicate documents in the database. This is corrected by determining four properties, such as, title, author, subject matter and year for each entry in the database. In an embodiment when the four properties of more than one entry matches a duplicate exits. Once the duplicate is detected, all matching entries except one are merged in to one entry in the database. In an embodiment of the invention, the first and last name of the author may be hashed to create an author name, which may be combined with the hash of the associated content, and the combined hash may be utilized to determine if a match occurs. In an alternate embodiment, the hash of the content is combined with the hash of the properties. In another embodiment, a match may be indicated when any combination of the four properties returns a match. Accordingly, when a match occurs across multiple entries in one or more fields of the database entry, duplicates are merged.

In an embodiment of the invention, the database may also include a copyright field indicating whether the associated file or reference is copyright protected. The copyright field may be useful when deciding whether to display a summary or full-length version of the content. In an embodiment, populating the database with the documents may occur as a batch process when the usage of the network is critical.

The extraction component 221 includes a harvesting engine 221A, a convertor 211B component and rules 221C. The harvesting engine 221A performs both direct and indirect communications when retrieving the documents. The harvesting component may utilize reference information included in current document to indirectly retrieve a subsequent document. In an embodiment, the convertor component 221B retrieves the documents from the document database 210 and normalizes the documents to a common format. In an embodiment of the invention, the convertor component 221B may include, but is not limited to, a PDF (Portable Document Format) convertor to convert .pdf files, an HTML (HyperText Markup Language) convertor to convert .html files, XML (eXtensible Markup Language) convertor to convert .xml files, and image convertors, such as OCR (Optical Character Recognition) to convert .jpg to .txt files. Each convertor of the convertor component 221B may coverts a file that is being processed to a common format, such as text.

The harvesting engine 221A retrieves the documents or references to the documents and populates the database 210 based on one or more rules 221 that define the document style and structure. For instance, font size, header and pagination information are utilized to ensure that the document citation can be located within the normalized format. The normalized documents are further processed based on the rules 221C to determine if the document represents a scholarly article. The rules 221C may include profile information that specifies when bold, italics, or font size may indicate a header portion of the document. The extraction component utilizes the profile information to verify that the document includes one or more citations. For example, the extraction component can search the identified header portions for indications that suggest a heading is a known portion of a research article, such as a reference section, title, references, footnote, endnote, etc. Once the document structure and style are analyzed the document is either verified to be a document having citation information, such as a scholarly article. Otherwise the document is a regular webpage that can be discarded if needed. Typically, when the documents include a reference section, the reference section is stored as a line item having a plurality of atoms, which are analyzed atom by atom. Each line item is processed to determine line atoms, such as author, title, year and publication, etc. The extracted atoms are associated with normalized document to provide access to the citation information for each normalized document.

In an embodiment of the invention, the extraction component includes machine instruction for devices that require training to provide the strongest possible extraction probability prior to actual use of the component. The machine instructions may initialize a machine-training algorithm that improves the accuracy when extracting information. In an embodiment, the machine-training algorithm utilizes a sample size that includes one percent of all the files stored in the database to tune the extraction component. The machine-training algorithm begins to parse through the sample size, and errors are corrected by a user so that the machine can learn from the errors to modify a neural network that captures specialized knowledge developed by human intelligence.

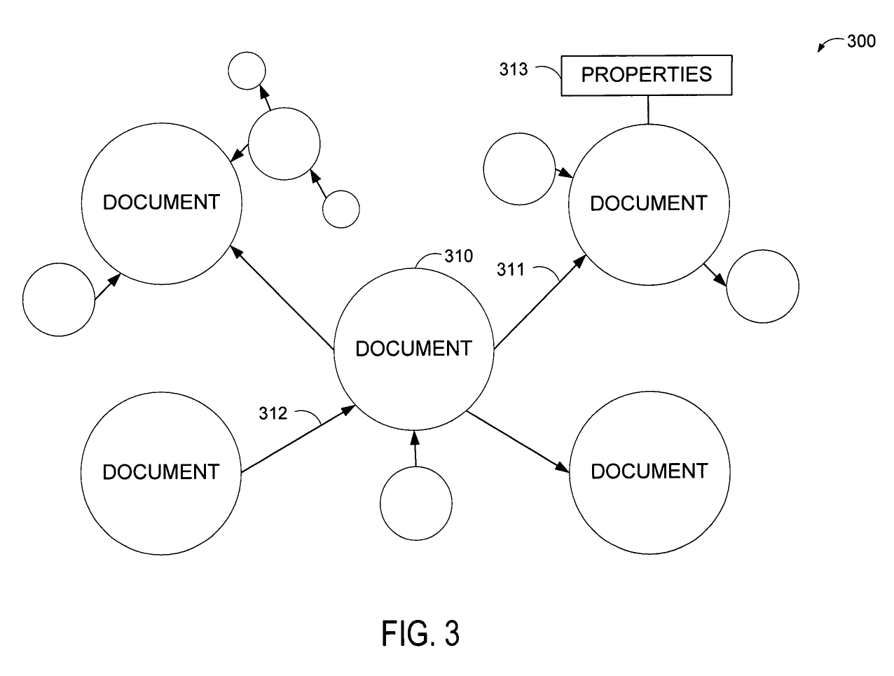

Once the documents have been processed and appropriate information is extracted a graph may be generated by the graph generation component 224 to represent the documents and the relationships between each document. With reference to FIGS. 2 and 3, the graph generation component 224 may generate a graph similar to graph 300 that illustrates the relationships between documents in a corpus of documents having disparate formats, according to an embodiment of the invention. Each node 310 of the graph 300 represents a document stored in the document database 210. The nodes are connected by links, where links include a first set of links and a second set of links. The first set of links 311 are links that connect the document to other nodes that were cited by the document. The second set of links 312 includes links that connect other document to the document because the other document cited to the document. Additionally each node is associated with a collection of properties 310 that provide information about the document, such as author, publisher, etc. The properties 310 may also include a weight for the node 310. In an embodiment, the weight may be a count of the second set of links associated with the node. Accordingly, the graph 300 organizes the documents and corresponding information to optimize efficiency and to allow the system to answer queries such as, “how many people cited document X,” and “how many people cite to author X”.

The graph generated by the graph generation component 224 may be utilized by the ranking component 220 to generate a rank for each document in the document database 210. The rank assigned to the document may be the weight assigned to the node representing the document. Alternatively, the rank may include a contribution from other nodes that cite to the document, where the weight of the other nodes are recursively reduced by a percentage and added to the weight of the node to become the rank of the node. In an embodiment, the weight of each subsequent node is reduced by a scale 10, thus for example, the factor for a set nodes beginning with the document may include 1, 0.1, 0.01, 0.001, etc end ending with infinity or a threshold number of nodes. In an embodiment of the invention, during ranking, when the document is cited to by a node associated with high distinctions or prestige, such as Nobel Peace Prize document, or Supreme Court document, the weight of the node having that distinction is giving a higher scaling factor than the other nodes. Thus if the other nodes had a scaling factor of 0.1 the node with a distinction would be assigned a larger scaling factor such as 0.2. Accordingly, the rank provides information on the relative importance of the document as a function of the citations to the document.

The notification component 223 may generate a message, email, voicemail, or instant message that communicates to the author of a document that has been cited by another document. In an embodiment, the author is provided with title, author, and subject matter information. In certain embodiments, the notifications are Rich Site Summary (RSS) notifications and the graphs may be formatted using XML. Accordingly, the author of each document is made aware of who cites the author.

After processing the documents in the document database 210, the citation service generates the citation listing 230, which include the citations and relationships between documents having the citations.

The citation listing 230 may include full length published content and metadata retrieved from a publisher. The citation listing 230 would also include OPI or OAI pre-print content accessed according to the OAI protocols or via a registration server, where the pre-print content is an electronic version of soon to be published material. In an embodiment, OPI pre-print content includes pre-print articles that are submitted and published according to OPI protocols. The OPI pre-print content represents a category of documents, where access to the OPI pre-print content is governed by OAI. Additionally, in certain embodiments the content may include commercial content and Internet content. The commercial content generated by a third-party and including value added information, such as related documents or topics for published content only. The Internet content is normally self-published, where a publisher has not agreed to publish the content. The content is categorized into one of the aforementioned types and presented to user, where access is limited when the content is copyright protected.

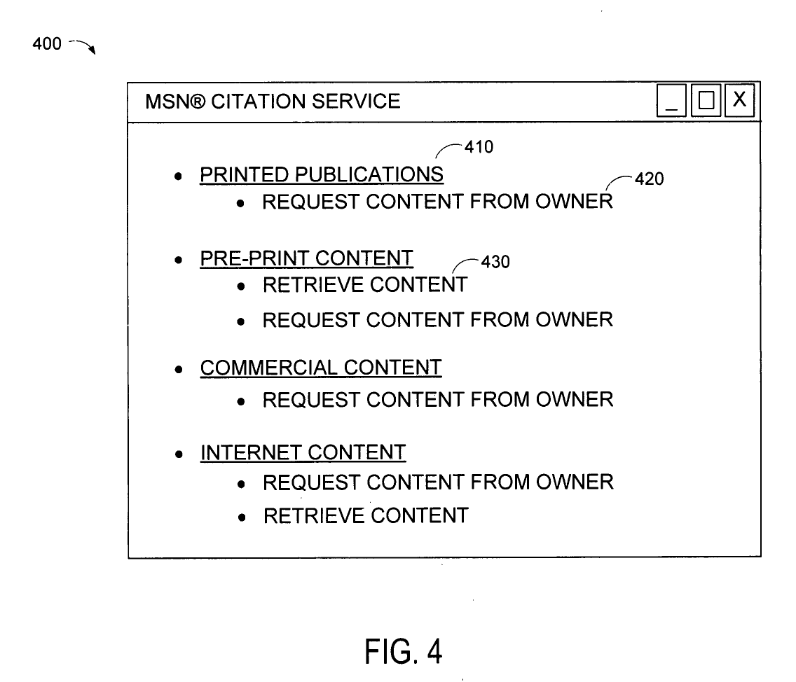

FIG. 4 is a graphical user interface 400 that illustrates a display that categorizes the citation information, according to an embodiment of the invention. The graphical user interface categorizes the citations and relationships. In an embodiment, citations are grouped into four categories (410). The four categories include printed publications that are received from a publisher that only publishes scholarly articles subject to an intensive review, which delays the publication of the scholarly articles; pre-print content that includes content that has been approved by a publication committee, but is in queue to be printed by a publisher; commercial content that is very similar to printed publications, except the commercial content may include other information that was retrieved and associated with the published content; and Internet content which includes document having citation information, such as scholarly articles that were self-published or web-published. When the content associated with each category includes copyright protected information the user is presented with the option to request content from owner 420, otherwise the user is only given access to non-copyright protected content 430.

A collection of sources may provide the documents that are processed to extract citation information. The citation information is tracked and associated with the document that provided the citation information. The citation information is utilized to determine the relationships between the documents.

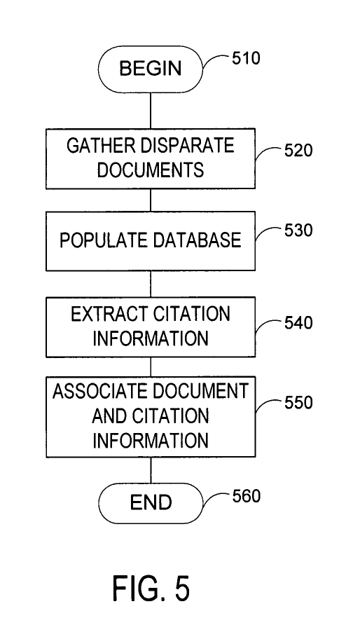

FIG. 5 is a logic diagram that illustrates a method to create citation relationships, according to an embodiment of the invention. The method begins in step 510 when the citation service is initialized. In step 520 disparate documents are gathered from one or more sources. In turn, the database is populated with disparate documents. In an embodiment, each of the disparate documents may match a style or structure associated with scholarly articles in step 530. The citation information from the stored documents is extracted based on one or more rules in step 540. The citations are associated with the corresponding document in step 550. The method ends in step 560.

Presenting a corpus of disparate documents provides an organized display of the disparate documents based on the source of the disparate documents. Displaying the documents may include ranking the documents to ensure that popular documents are presented before less popular documents.

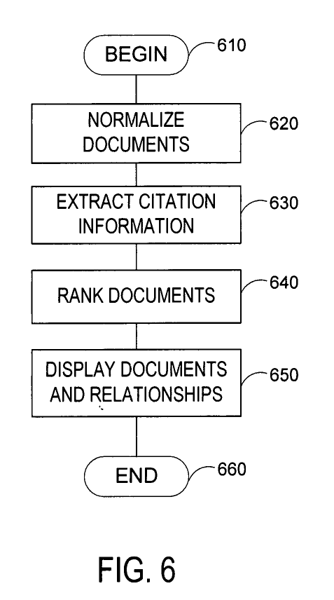

FIG. 6 is a logic diagram that illustrates a method to present a corpus of disparate documents, according to an embodiment of the invention.

The method begins in step 610 after the documents have been gathered. The documents having disparate formats are normalized to a common format in step 620. The normalized documents are processed to extract citation information in step 630. In step 640, the normalized documents are ranked based on the extracted citation information, which provides relationship information for a set of normalized documents. The document and relationships are displayed in step 650. The method ends in step 660.

In summary, aggregating citation information from disparate sources provides an efficient method to present relationships between scholarly articles in an area of development. Furthermore, the importance of a document can be determined based on the citation utilization. Accordingly, the citation information may reliably extract citation from documents having disparate formats.

In an alternate embodiment, a method for notifying an author when a citation has occurred is provided. The author generates content that is stored in a document database. The content is processed to extract citation information. The cited authors included in the citation information are contacted and informed of the current citation.

The foregoing descriptions of the invention are illustrative, and modifications in configuration and implementation will occur to persons skilled in the art. For instance, while the present invention has generally been described with relation to FIGS. 1-6, those descriptions are exemplary. Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims. The scope of the invention is accordingly intended to be limited only by the following claims.

We claim:

1. A method to create citation relationships, the method comprising:
gathering documents from one or more sources;
populating a database with the documents;
extracting citation information based on one or more rules that define a document pattern; and
associating each document matching the document pattern with the citation information.

2. The method according to claim 1, wherein the documents include documents having disparate formats.

3. The method according to claim 1, wherein the sources include at least one of a publishing company, a publisher, a self-publisher, and a commercial database

4. The method according to claim 1, wherein gathering the documents from the one or more sources further comprises, crawling the Internet.

5. The method according to claim 1, wherein populating the database with the documents further comprises, merging duplicate database entries.

6. The method according to claim 5, wherein the duplicate database entries are merged when one or more database entries have a title, author, year and publisher that match an existing database entry.

7. The method according to claim 1, wherein the rules utilize style and font information to extract citation information from the document.

8. The method according to claim 7, wherein extracting citation information based on one or more rules that define the document pattern further comprises, checking a document structure to determine if the document matches patterns associated with scholarly articles.

9. The method according to claim 8, wherein checking a document structure to determine if the document matches patterns associated with scholarly articles further comprises, searching for a portion of the document having one or more citations.

10. The method according to claim 9, wherein the portions include at least one of a footnote, an endnote, or a reference portion.

11. The method according to claim 1, further comprising:
generating a graph having nodes that represent a document and links that connect each node, and for each node a first set of links represent relationships with other documents cited from the document and a second set of links represent relationships with other documents that cited to the document.

12. The method according to claim 11, wherein each node includes a weight based on the second set of links, wherein the weight contributes to a rank of each document.

13. A method to present a corpus of disparate documents and related citations, the method comprising:
normalizing the corpus of disparate documents;
extracting citation information from the corpus of documents;
ranking each document based on the citation information; and
displaying ranked documents and relationships between the ranked documents.

14. The method according to claim 13, wherein normalizing the corpus of disparate documents further comprises converting the each disparate document in the corpus to a native format.

15. The method according to claim 13, wherein ranking each document based on the citation information comprises generating a graph to rank the documents.

16. The method according to claim 15, wherein the generated graph comprises nodes representing each document and links that connect each node, and for each document a first set of links representing other documents cited from each document and a second set of links representing other documents citing to each document.

17. The method according to claim 16, wherein a count of the second set of links is utilized to generate a weight for each document, and the weight of other documents connected to each document contributes to the weight of each document to generate a rank for each document.

18. The method according to claim 17, wherein the weight of other nodes varies on distinctions associated with the documents represented by the other nodes.

19. The method according to claim 17, wherein distinctions associated with other documents authored by prestigious authors affect the weight of each document more than the weight of documents authored by non-prestigious authors.

20. A system to provide citation information, the system comprising:
a retrieval service to retrieve documents from one or more sources;
a normalization service to normalize the retrieved documents,
a citation service to extract citation information from the normalized documents and to generate citation listings representing relationships between the normalized documents, wherein a structure and style associated with the normalized documents are analyzed to extract the citation information;
a ranking service to rank the retrieved documents based on the citation information; and
a presentation component that utilizes the citation listings to graphically represent the relationships.
